(19) United States
(12) Patent Application Publication
(10) Pub. No.: US 2025/0299076 A1
(43) Pub. Date: Sep. 25, 2025

(54) AUTOMATED CORPUS TOOL GENERATOR FOR AGENTS

(71) Applicant: INTUIT INC., Mountain View, CA (US)

(72) Inventor: Richard J. BECKER, Mountain View, CA (US)

(73) Assignee: INTUIT INC., Mountain View, CA (US)

(21) Appl. No.: 18/611,543

(22) Filed: Mar. 20, 2024

(51) Int. Cl. G06N 5/043

(52) U.S. Cl. CPC G06N 5/043

(57) ABSTRACT

A method for generating domain knowledge tools for a Large Language Model (LLM) agent. The method receives a corpus of documents in multiple formats, converts and analyzes the corpus to generate a domain specific agent that creates and maintains domain knowledge tools that provide domain-specific contextually relevant information to the LLM agent. The domain knowledge tools enhance the LLM agent processing of user queries by supplying domain-specific information and context during the LLM agent generation of responses.

### BACKGROUND

The field of artificial intelligence, specifically machine learning and natural language processing, has seen rapid advancements in recent years. Large Language Models (LLMs) are a subset of these advancements, designed to understand, generate, and complete human-like text based on a given input. These models are trained on a vast corpus of text data, enabling them to generate contextually relevant responses. However, the accuracy and relevance of these responses are heavily dependent on the quality and specificity of the training data. In many applications, it is desirable to have LLMs that can provide accurate responses in specific domains, such as human resources, tax assistance, regulatory compliance, and payroll requirements.

Traditionally, to achieve domain-specific accuracy, LLMs are fine-tuned or re-trained on a specific domain corpus, or a vectorized version of the corpus is manually created. These methods, however, are time-consuming, costly, and require manual intervention—all of which are undesirable.

### SUMMARY

Embodiments disclosed herein solve the aforementioned technical problems and may provide other technical solutions as well. Contrary to conventional techniques that must re-train LLMs, one or more embodiments disclosed herein implement a domain specific agent that automatically creates and maintains domain knowledge tools that provide domain-specific contextually relevant information to the LLM agent, thereby obviating the need to train the LLM agent for different domains.

An example embodiment includes a method for generating domain knowledge tools for a Large Language Model (LLM) agent. The method comprising analyzing a corpus of documents using a series of machine learning models to extract generalized information about the corpus, and generating a domain specific agent that utilizes the generalized information to create and maintain domain knowledge tools that provide domain-specific contextually relevant information to the LLM agent, the domain knowledge tools enhancing the LLM agent processing of user queries by supplying domain-specific information and context during the LLM agent generation of responses.

An example embodiment includes a method of a Large Language Model (LLM) agent utilizing domain knowledge tools. The method comprising receiving a user query, accessing domain knowledge tools that provide domain-specific contextually relevant information to the LLM agent, the domain knowledge tools enhancing the LLM agent in processing of user queries by supplying domain-specific information and context during the LLM agent in generation of responses, the domain knowledge tools generated from generalized information extracted from a corpus of documents using a series of machine learning models, and generating a response to the user query based on the accessed domain knowledge tools.

An example embodiment includes a system for generating domain knowledge tools for a Large Language Model (LLM) agent. The system comprising a database storing a corpus of documents; and a processor configured to analyze the corpus of documents using a series of machine learning models to extract generalized information about the corpus, and generate a domain specific agent that utilizes the generalized information to create and maintain domain knowledge tools that provide domain-specific contextually relevant information to the LLM agent, the domain knowledge tools enhancing the LLM agent processing of user queries by supplying domain-specific information and context during the LLM agent generation of responses.

### BRIEF DESCRIPTION OF THE DRAWINGS

So that the way the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 illustrates an example system diagram for an automated corpus tool generator for agents, according to aspects of the present disclosure.

FIG. 2A presents an example diagram of an overall system or process for processing information, according to aspects of the present disclosure.

FIG. 2B outlines an example method for processing documents to be used by a Large Language Model (LLM), according to aspects of the present disclosure.

FIG. 3A illustrates the interaction between a user, user interface, an LLM Agent, and various tools and components within a system, according to aspects of the present disclosure.

FIG. 3B outlines the process by which an LLM handles a user query, according to aspects of the present disclosure.

FIG. 4 presents a block diagram of an example computing system, illustrating the interconnection of its components, according to aspects of the present disclosure.

### DETAILED DESCRIPTION OF SEVERAL EMBODIMENTS

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatuses as known by one of ordinary skill in the relevant art may not be discussed in detail but are intended to be part of the specification where appropriate. In all the examples illustrated and discussed herein, any specific values should be interpreted to be illustrative and non-limiting. Thus, other example embodiments may have different values. It is noted that similar reference numerals and letters refer to similar items in the figures, and once an item is defined for one figure, it is possible that it need not be further discussed for the other figures.

The present disclosure relates to an automated corpus tool generator for agents, which is designed to enhance the functionality and accuracy of LLMs. The automated corpus tool generator, in some cases, may ingest a corpus of information, which may be large or small, and convert it into a format that can be used by LLMs as a reference for further inference. This process may be automated, eliminating the time-consuming and costly methods of fine-tuning, re-training, or manually creating a vectorized version of the corpus.

In some cases, the automated corpus tool generator may use a series of models and LLM prompts to derive the metadata associated with a corpus. More specifically, it may focus on the semantically related sections that are extracted and processed section by section. The resultant metadata can be utilized to create domain-specific vectorized datastores that allow LLMs to perform more accurately with no additional manual intervention.

The automated corpus tool generator in accordance with the disclosed principles may provide a method that allows for the automatic ingestion of a corpus in a variety of forms and creates the associated metadata using a series of models and LLM prompts. The result is a bespoke reference that can be accessed efficiently by the LLM to provide more accurate completions based upon specific prompts.

The automated corpus tool generator may be used across various domains by creating specific agents for each domain. The LLM may access the appropriate domain specific agent based on the user query. For example, if the user query is in the domain of tax document preparation, the LLM may utilize a created tax domain specific agent. For instance, in the domain of tax document preparation, the inventive solution would implement an automated process where the LLM agent leverages a tax domain-specific agent created by the system. This agent is designed to automatically ingest and analyze a corpus of tax-related documents, converting them into a digestible format and extracting generalized information to build domain knowledge tools. These tools, which include vectorized datastores of domain-specific information, enable the LLM agent to access and utilize contextually relevant tax information, such as regulations and filing procedures, to generate accurate and pertinent responses to user queries regarding tax document preparation. Further details of creating and utilizing the domain specific agents are described below.

It is noted that the solution disclosed herein demonstrates a practical application specific to LLM processing. Specifically, the creation of a domain specific agent by the automated corpus tool generator for agents constitutes a concrete application of artificial intelligence and machine learning principles that directly impacts the functionality of LLMs. This practical application is rooted in the technological task of enabling LLMs to respond to user requests with high accuracy while overcoming problems with traditional solutions that require resource-intensive requirements of retraining the LLM for each specific domain. By automating the generation of domain knowledge tools, the inventive solution provides a tangible benefit and a technological improvement over the state of the art in the form of enhanced efficiency and accuracy in the processing of user queries, which is a clear indication of its application in a real-world context. The inventive solution allows the LLM to utilize these tools to generate responses that are not just contextually appropriate but also domain-specific, thereby solving the technical problem of domain-specific accuracy without the drawbacks of manual intervention and retraining of the LLM. In other words, the LLM may utilize the domain specific agents to provide specialized guidance when responding to domain specific requests from users.

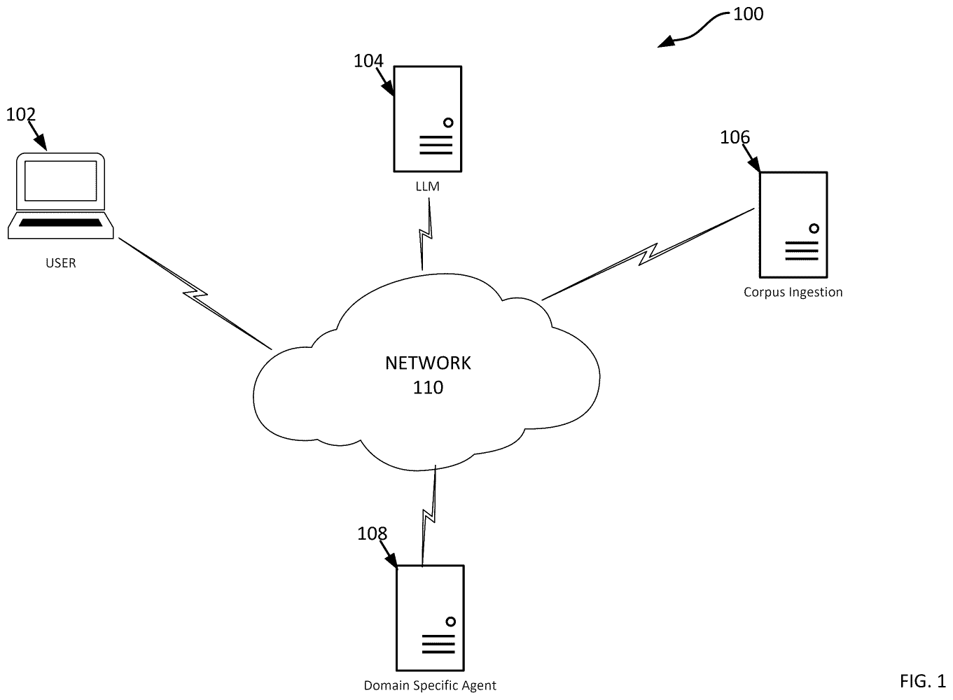

Referring to FIG. 1, a system 100 for an automated corpus tool generator for agents in accordance with the disclosed principles is illustrated. The system 100 includes various devices interconnected via a network 110, which serves as a communication hub. In some examples, the system 100 includes a user device 102, an LLM server 104, a corpus ingestion server 106, and a domain specific agent server 108.

User device 102, connected to the network 110, provides an interface for users to interact with the system. In some cases, the user device 102 may be a computer, a smartphone, a tablet, or any other device capable of connecting to the network 110 and facilitating user interaction.

LLM server 104, also connected to the network 110, represents the core processing unit that utilizes the ingested corpus. In some examples, LLM server 104 may be configured to process user queries, generate responses, and interact with other components of the system diagram 100.

The corpus ingestion server 106, depicted with a connection to the network 110, plays a role in processing and preparing the raw data for LLM server 104. In some cases, the corpus ingestion server 106 may accept raw documents in various formats including PDF, TXT, CSV, IMG, etc., and convert them into a format that is acceptable for downstream processing. This conversion process may involve various techniques such as text extraction, image recognition, data normalization, and others.

Domain specific agent server 108, connected to the network 110, provides specialized assistance based on the processed corpus data. In some examples, the domain specific agent server 108 may generate domain knowledge tools that provide domain-specific contextually relevant information to LLM server 104. These domain knowledge tools may enhance the processing of user queries by supplying domain-specific information and context during the generation of responses. In some cases, the domain knowledge tools may be generated by a plurality of domain specific agents to assist the LLM server 104 in providing accurate responses in various domains.

While the system 100 depicted in FIG. 1 shows a single user device 102 and individual servers such as the LLM server 104, corpus ingestion server 106, and the domain specific agent server 108, it is to be understood that this is merely illustrative and not restrictive. In practice, the system may include multiple user devices and multiple instances of each server type, all interconnected via the network 110. This allows for scalability and robustness in the system's operation, accommodating a large number of users and ensuring uninterrupted service even in the event of high demand or individual server failure. Therefore, the depiction of single devices and servers in the figures is for simplicity and clarity of explanation and does not limit the actual implementation of the system.

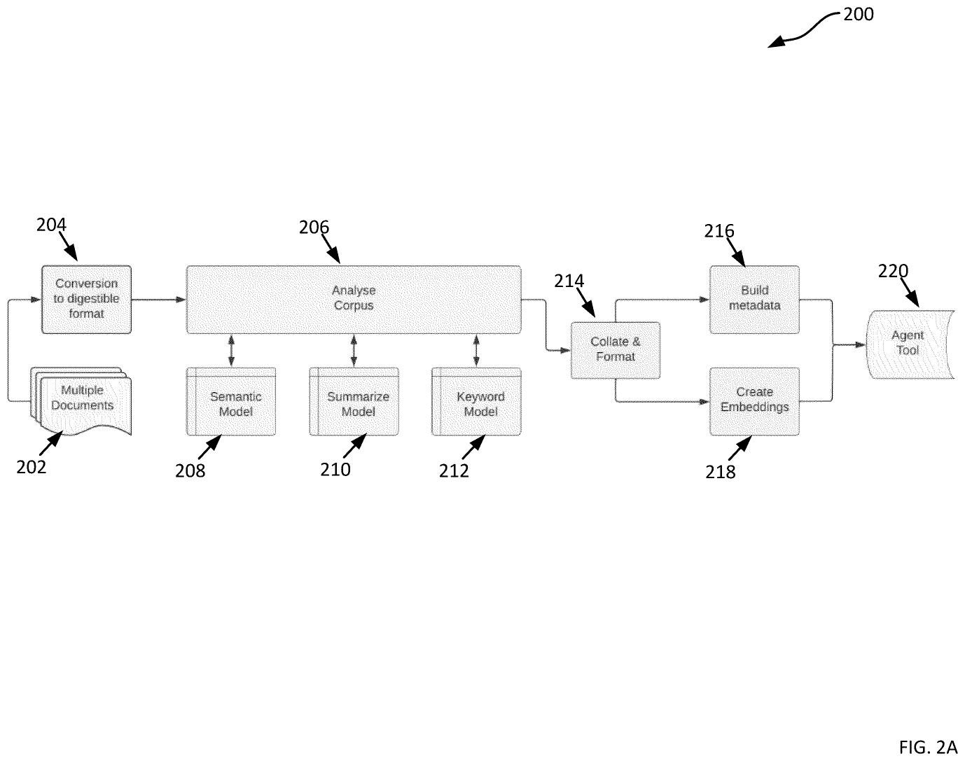

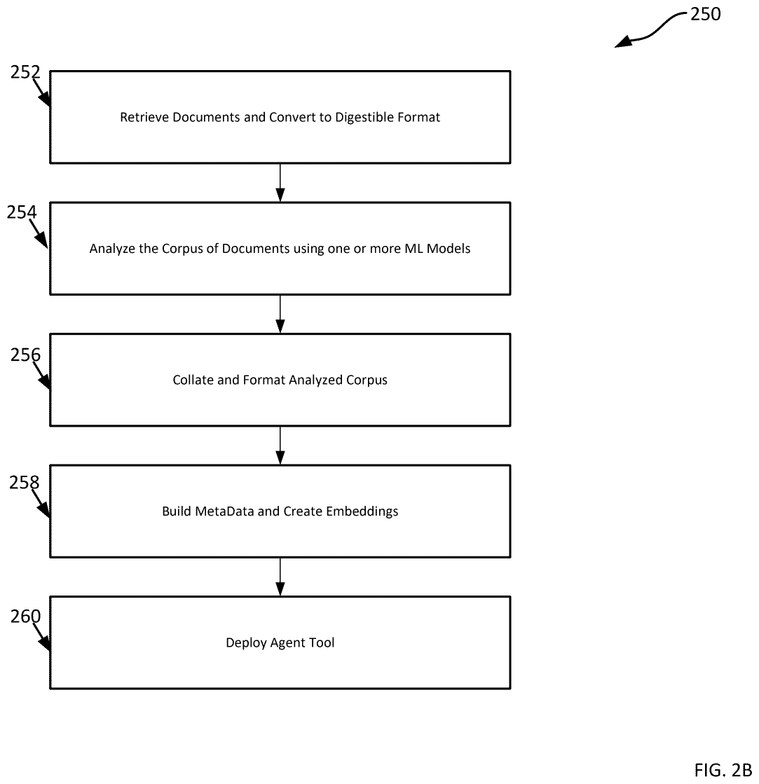

Referring now to FIG. 2A, an overall process 200 for processing information in accordance with the disclosed principles is illustrated. The process 200 begins with receiving, retrieving and/or inputting multiple documents 202, which may be in various formats such as PDF, TXT, CSV, IMG, and others. In some cases, these documents may represent a corpus of information related to a specific domain (e.g., tax document preparation). The multiple documents 202 are converted into a digestible format 204. This conversion process may involve various techniques such as text extraction, image recognition, data normalization, and others. In some examples, the conversion of the multiple documents 202 into a digestible format 204 involves converting formatted documents into a text or binary equivalent format. This conversion allows for the subsequent analysis of the corpus of documents.

Once multiple documents 202 have been converted into a digestible format 204, they undergo analysis by analyze corpus 206. This analysis may involve the use of a series of machine learning models to extract generalized information about the corpus. The analysis may include discerning logical or semantic groupings within the corpus, resulting in sections within the corpus. For each section, further analysis may be performed to provide representative keywords, correlation to predefined categories, summarization of section corpus, and identification of related sections and correlation between each section.

Generalized information may be a condensed form of data that is derived from a more extensive and detailed set of documents. It is the result of an abstraction process where the primary and salient points are extracted from a corpus of documents (e.g., text documents). This extraction process focuses on identifying the main themes, concepts, patterns, and relationships that are prevalent throughout the corpus. By distilling the data in this manner, the generalized information represents the essence of the corpus, encapsulating the core knowledge or insights that are common and relevant to the various documents within the corpus. The generalized information is used in the construction of domain knowledge tools by the domain specific agent. This information, once extracted and synthesized from the corpus, serves as the raw material from which the domain knowledge tools are crafted. The domain specific agent employs this generalized information to build a suite of tools that include, but are not limited to, vectorized datastores, metadata repositories, and context-aware response generators. These tools are then leveraged by the LLM agent to enhance its ability to process and respond to user queries with a high degree of domain specificity and contextual relevance. The domain knowledge tools, thus, are a direct manifestation of the generalized information, transformed into actionable assets that empower the LLM agent to deliver precise and pertinent information in response to domain-specific inquiries.

In other words, with this analysis, a semantic model 208, a summarize model 210, and a keyword model 212 may be applied to the converted data. The semantic model 208, for example, may be used to discern the various logical or semantic groupings within the corpus. The summarize model 210, for example, may be used to provide a summarization of the section corpus. The keyword model 212, for example, may be used to provide representative keywords for each section. The results of these models are then collated and formatted 214, leading to the creation of build metadata 216.

In some examples, the build metadata 216 may be generated based on the results of the semantic model 208, the summarize model 210, and the keyword model 212. The build metadata 216 may include, for each section of the corpus, the identified semantic groupings, the generated summary, and the identified keywords or phrases. This metadata may provide a comprehensive overview of the content of the corpus, which can be used for further processing and analysis.

In some cases, the build metadata 216 may also include additional information derived from the analysis of the corpus. For example, the build metadata 216 may include information about the correlation of each section to predefined categories, the determination of an appropriate title for each section, and the identification of related sections and the correlation between each section. This additional information may further enhance the understanding of the content of the corpus and may be used to improve the accuracy and relevance of the responses generated by the LLM agent.

This metadata is used to create embeddings 218, which are then utilized by an agent tool 220 to perform specific tasks or answer queries. In some examples, the embeddings 218 may be generated based on the build metadata 216. The embeddings 218 may represent a vectorized version of the metadata, which can be efficiently processed by machine learning models such as LLMs. The embeddings 218 may be generated section by section and named according to the model outputs. Descriptions are generated and any other relevant metadata. All of this information can be utilized to create a bespoke tool for integration with standard LLM Agent Models/Processing.

The creation of embeddings 218 may involve various techniques such as word embedding, sentence embedding, or document embedding. These techniques may convert the textual information in the metadata into numerical vectors, which can be processed by machine learning models. The embeddings 218 may capture the semantic meaning and context of the sections in the corpus, which can be used to improve the accuracy and relevance of the responses generated by the LLM agent.

Following the creation of embeddings 218, the overall process 200 culminates with the deployment of the agent tool 220. As mentioned above, agent tool 220 is a domain-specific agent that creates and maintains domain knowledge tools that provide domain-specific contextually relevant information to the LLM agent. These domain knowledge tools may enhance the LLM agent processing of user queries by supplying domain-specific information and context during the LLM agent generation of responses. In some cases, the agent tool 220 may be a domain-specific agent that creates and maintains domain knowledge tools that provide domain-specific contextually relevant information to the LLM agent. These domain knowledge tools may enhance the LLM agent processing of user queries by supplying domain-specific information and context during the LLM agent generation of responses. The agent tool 220 may utilize the embeddings 218 to provide accurate completions based upon specific prompts. In some examples, the agent tool 220 may be automatically updated by the domain specific agent as the corpus is updated, reflecting changes as updates occur.

The agent tool 220, as referenced in the overall process 200, may be a software component or module that interfaces with the LLM agent to enhance its capabilities. It is designed to perform specific tasks or answer queries by utilizing the domain knowledge tools. The agent tool 220 is the executable aspect of the system that directly interacts with the LLM agent, providing it with the means to access and apply the domain knowledge tools in processing user queries. The domain-specific agent is a specialized version of the agent tool 220 that is tailored to a particular domain or field of knowledge. It is created by the automated corpus tool generator and is responsible for creating and maintaining the domain knowledge tools relevant to its specific domain. The domain-specific agent is an intelligent intermediary that understands the context and nuances of its designated domain, ensuring that the LLM agent receives the domain-specific information it requires to generate accurate and relevant responses. The domain knowledge tools are the resources and data structures generated by the domain-specific agent. These tools include vectorized datastores of domain-specific information, metadata, and embeddings that encapsulate the semantic meaning and context of the domain's corpus. The domain knowledge tools are designed to provide the LLM agent with contextually relevant information and assist in the accurate generation of responses to user queries within the domain.

The relationship between the agent tool, domain-specific agent, and domain knowledge tools is hierarchical. The domain-specific agent is a type of agent tool that is focused on a particular domain, and it generates the domain knowledge tools that are used by the agent tool to assist the LLM agent. In other words, the domain knowledge tools are the end product of the domain-specific agent's processing and analysis of the domain corpus, and they serve as the informational foundation that the agent tool leverages to enhance the LLM agent's performance. While the agent tool is a general component that interacts with the LLM agent, the domain-specific agent is a specialized creator and maintainer of domain knowledge tools for a particular domain. The domain knowledge tools are the actual informational assets that are used by the agent tool to provide domain-specific assistance to the LLM agent. In other words, the LLM agent interacts with the domain knowledge tools for the immediate processing of user queries, while the domain-specific agent works in the background to generate and refresh these tools to ensure accurate and up-to-date information. The domain specific agent may automatically update the domain knowledge tools as new data is added to the corpus or as existing data is modified. This ensures that the information remains current and reflects the latest knowledge within the domain. Each element described above plays a distinct role, yet they are interconnected and dependent on one another to achieve the goal of enhancing the LLM agent's ability to process user queries with high domain-specific accuracy and relevance.

Turning now to FIG. 2B, a flowchart outlines a method 250 for processing documents to be used by an LLM in accordance with the disclosed principles. The method 250 begins with the step of retrieving documents and converting them to a digestible format (at 252). In this step, documents are collected and formatted for analysis. The documents may be in various formats such as PDF, TXT, CSV, IMG, and others. These documents may represent a corpus of information related to a specific domain. The documents are converted into a digestible format suitable for downstream processing. This conversion process may involve various techniques such as text extraction, image recognition, data normalization, and others. In some examples, the conversion of the documents into a digestible format involves converting formatted documents into a text or binary equivalent format. This conversion allows for the subsequent analysis of the corpus of documents.

Following the retrieval and conversion of documents, the process 250 proceeds to analyze the corpus of documents using one or more ML models (at step 254). In this step, machine learning models are used to examine the corpus. The analysis may involve the use of a series of machine learning models to extract generalized information about the corpus. In some cases, the analysis may include discerning logical or semantic groupings within the corpus, resulting in sections within the corpus. For each section, further analysis may be performed to provide representative keywords, correlation to predefined categories, summarization of section corpus, and identification of related sections and correlation between each section.

Once the corpus of documents has been analyzed, the process 250 moves to collating and formatting the analyzed corpus (at step 256). In this step, the analyzed data is organized for further processing. This may involve organizing the results of the models in a structured format, such as a database or a structured document. The collated and formatted results may include, for each section of the corpus, the identified semantic groupings, the generated summary, and the identified keywords or phrases. This information may provide a comprehensive overview of the content of the corpus, which can be used for further processing and analysis.

Subsequently, the process 250 proceeds to building metadata and creating embeddings (at step 258). In this step, metadata is generated, and embeddings are created for each section. The metadata may include, for each section of the corpus, the identified semantic groupings, the generated summary, and the identified keywords or phrases. This metadata may provide a comprehensive overview of the content of the corpus, which can be used for further processing and analysis. The embeddings represent a vectorized version of the metadata, which can be efficiently processed by machine learning models such as LLMs. The embeddings may be generated section by section and named according to the model outputs. Descriptions are generated and any other relevant metadata. This information can be utilized to create a bespoke tool for integration with standard LLM Agent Models/Processing. This tool enhances the functionality of LLMs by providing them with domain-specific, contextually relevant information, thereby improving the accuracy of their responses to user queries.

Finally, the process 250 culminates by deploying the agent tool (at step 260). In this step, the agent tool is launched, ready to be integrated with LLMs for specific applications. The agent tool may be a domain-specific agent that creates and maintains domain knowledge tools that provide domain-specific contextually relevant information to the LLM agent. These domain knowledge tools may enhance the LLM agent processing of user queries by supplying domain-specific information and context during the LLM agent generation of responses. The agent tool may utilize the embeddings to provide accurate completions based upon specific prompts. In some examples, the agent tool may be automatically updated by the domain specific agent as the corpus is updated, reflecting changes as updates occur.

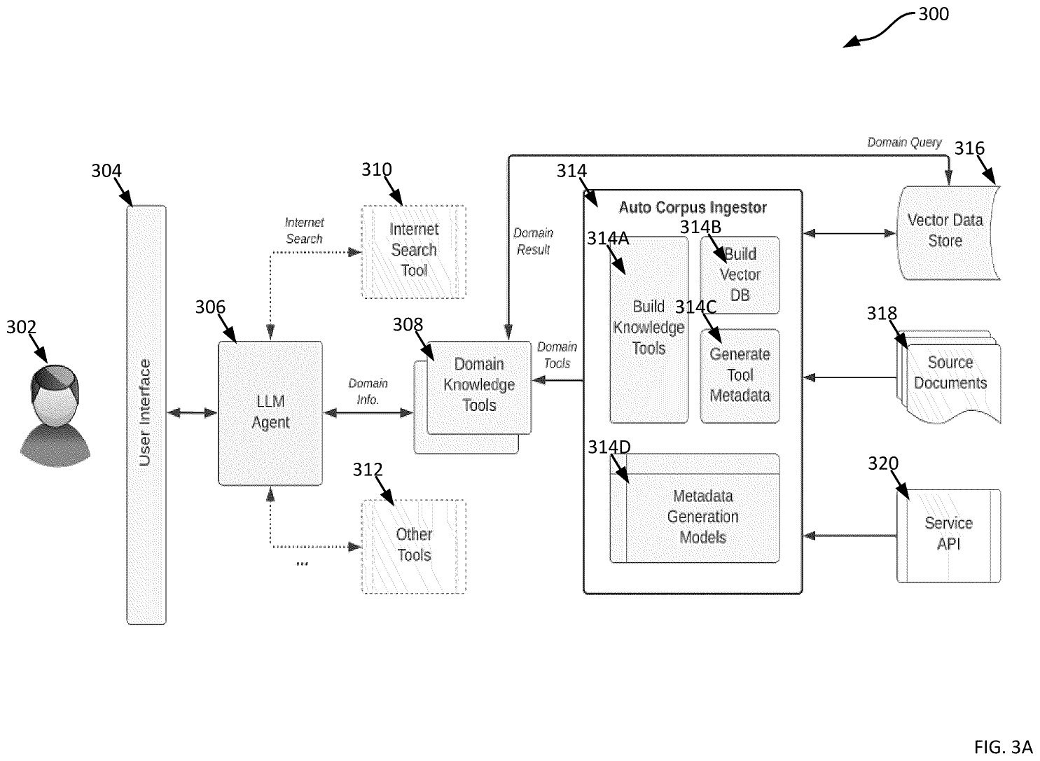

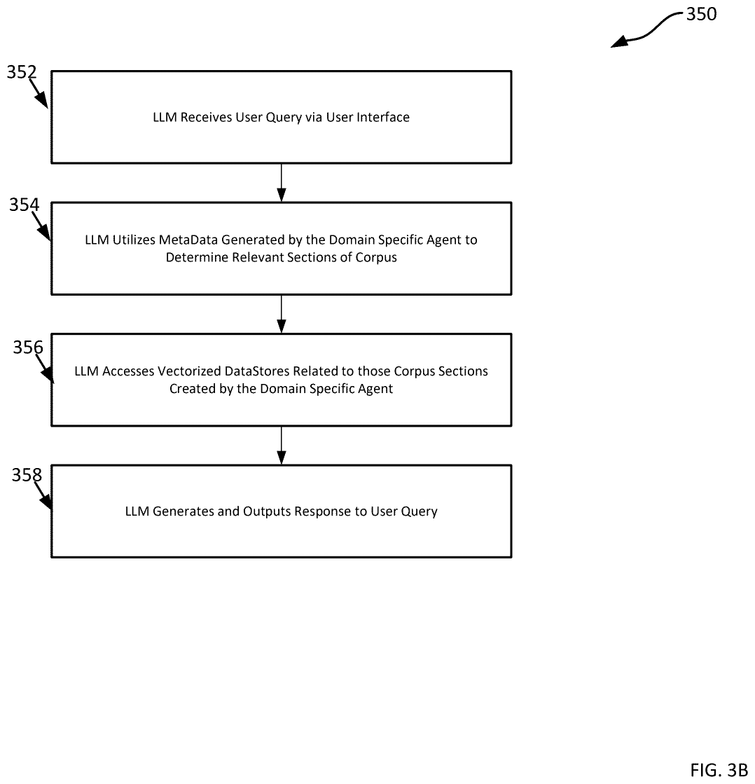

Turning now to FIG. 3A, example interactions 300 between a user 302, user interface 304, an LLM Agent 306, and various tools and components within a system are now described. The user 302 interacts with the system through the user interface 304, which communicates with the LLM Agent 306. The user interface 304, in some cases, may be a graphical user interface, a command line interface, or any other type of interface that allows the user 302 to interact with the system. The user interface 304 may be configured to receive user inputs, such as queries or commands, and to display responses generated by the LLM Agent 306.

The LLM Agent 306, in some examples, may be an LLM that processes user queries and generates responses. The LLM Agent 306 may have access to various tools and components within the system, which it uses to process a domain specific query. These tools and components may include domain knowledge tools 308, an internet search tool 310, and other tools 312. The domain knowledge tools 308, in some cases, may provide domain-specific contextually relevant information to the LLM Agent 306. These domain knowledge tools 308 may enhance the LLM Agent 306's processing of user queries by supplying domain-specific information and context during the generation of responses.

In some examples, the domain knowledge tools 308 may be generated by a domain specific agent, such as the auto corpus ingestor 314. The auto corpus ingestor 314 may receive source documents 318 and process them through components such as build vector database 314B, build knowledge tools 314A, and generate tool metadata process 314C, with the help of metadata generation models 314D. The processed information is stored in a vector data store 316 and can be accessed via a service API 320. The LLM Agent 306 uses the domain knowledge tools 308 to provide domain-specific information in response to the domain query.

In some cases, the generation of the domain knowledge tools 308 involves the creation of domain-specific vectorized datastores that are utilized by the LLM Agent 306 to access the domain specific information and assist the LLM Agent 306 in the generation of the responses. In other cases, the domain knowledge tools 308 are updated automatically by the domain specific agent as the corpus is updated, and changes are reflected as updates occur. In yet other cases, the domain knowledge tools 308 are generated by a plurality of domain specific agents to assist the LLM Agent 306 in providing accurate responses in various domains serviced by the system.

The LLM Agent 306, In some examples, has the ability to call upon various tools, and makes those selections based upon relevant metadata associated with the tool. The LLM Agent 306 attempts to answer a query by reasoning out the steps and can utilize provided data from the vector data store 316. This allows the LLM Agent 306 to provide accurate completions based upon specific prompts, reducing hallucinations and ensuring more accurate results.

Turning now to FIG. 3B, a flowchart outlines the process 350 by which an LLM handles a user query in accordance with the disclosed principles. The process 350 begins with the LLM receiving a user query via a user interface in step 352. The user interface, in some cases, may be a graphical user interface, a command line interface, or any other type of interface that allows the user to interact with the system. The user interface may be configured to receive user inputs, such as queries or commands, and to display responses generated by the LLM.

Upon receiving a user query, the LLM utilizes metadata generated by the domain-specific agent at step 354 to determine relevant sections of the corpus. The metadata, in some examples, may include information about the semantic groupings, summaries, and keywords or phrases associated with each section of the corpus. This metadata may provide a comprehensive overview of the content of the corpus, which can be used by the LLM to determine the relevant sections of the corpus for processing the user query.

Subsequently, the LLM accesses vectorized datastores related to those corpus sections created by the domain-specific agent at step 356. The vectorized datastores, in some cases, may represent a vectorized version of the metadata, which can be efficiently processed by the LLM. The vectorized datastores may capture the semantic meaning and context of the sections in the corpus, which can be used to improve the accuracy and relevance of the responses generated by the LLM.

In some examples, the LLM may utilize the domain knowledge tools to provide accurate completions based upon specific prompts. These domain knowledge tools may enhance the LLM's processing of user queries by supplying domain-specific information and context during the generation of responses. In other cases, the LLM may utilize the domain knowledge tools to reduce hallucinations and ensure accurate results in response to the user queries.

The LLM generates and outputs a response to the user query at step 358. The response, in some cases, may be generated based on the information accessed from the vectorized datastores and the domain knowledge tools. The response may be displayed to the user via the user interface, providing the user with accurate and contextually relevant information in response to their query.

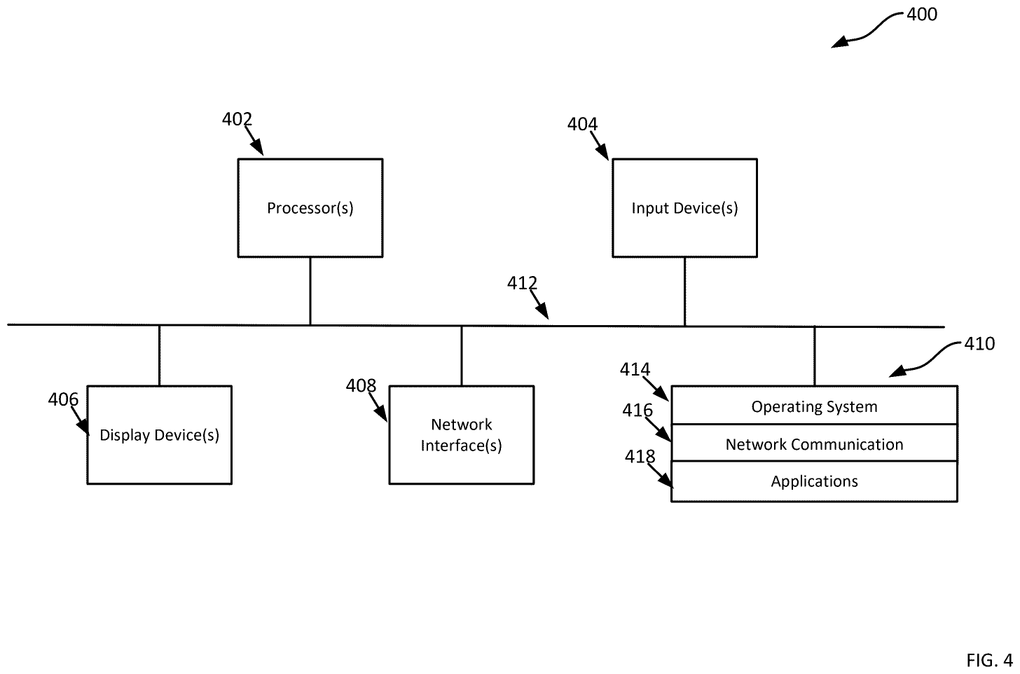

Referring now to FIG. 4, a block diagram of a computing system 400 is illustrated, showing the interconnection of its various components. The computing system 400 may represent the hardware of the user device 102 and the servers, such as the LLM server 104, the corpus ingestion server 106, and the domain specific agent server 108 of FIG. 1.

Centrally connected to a communication bus 412 are processors 402. The processors 402 may be one or more central processing units (CPUs), graphics processing units (GPUs), or any other type of processing units that perform the computations and operations of the computing system 400. In some cases, the processors 402 may execute the software elements 410, which include the operating system 414 and applications 418.

Input devices 404 and display devices 406 are also connected to the communication bus 412. The input devices 404 may include keyboards, mice, touchscreens, or any other devices that allow a user to input commands or data into the computing system 400. The display devices 406, on the other hand, may include monitors, screens, or any other devices that visually present data or information to the user. In some examples, the input devices 404 and display devices 406 facilitate user interaction with the computing system 400.

Network interfaces 408, which are likewise connected to the communication bus 412, facilitate external connectivity. The network interfaces 408 may include wired or wireless interfaces that allow the computing system 400 to connect to external networks, such as the network 110. In some cases, the network interfaces 408 may enable the computing system 400 to communicate with other devices or servers over the network 110 (FIG. 1).

The software elements 410, which include the operating system 414 and applications 418, are shown as being part of the computing system 400. The operating system 414, In some examples, manages the hardware resources of the computing system 400 and provides various services for the applications 418. The applications 418, on the other hand, may include various software programs or applications that perform specific tasks or functions on the computing system 400. In some cases, the applications 418 may include the software components of the large language model server 104, the corpus ingestion server 106, and the domain specific agent server 108 shown in FIG. 1.

Network communication 416 is depicted as a function of the operating system 414. The network communication 416 may involve various protocols and techniques for transmitting and receiving data over the network 110 (FIG. 1). In some examples, the network communication 416 may enable the computing system 400 to communicate with other devices or servers over the network 110, facilitating the exchange of data and information within the system 100 shown in FIG. 1.

In some examples, the automated corpus tool generator for agents, as part of the system diagram 100, may be utilized across a wide range of applications, demonstrating its versatility and adaptability. The automated corpus tool generator can be tailored to various domains, making it a valuable tool for a multitude of use cases.

For instance, the system may be employed in the realm of tax assistance and advice. In this scenario, the automated corpus tool generator (according to the method in FIG. 2B) may ingest a corpus of tax-related documents, generate domain-specific tools, and provide the LLM agent with accurate, contextually relevant information about tax regulations, procedures, and forms. This may enable the LLM agent (according to the method in FIG. 3B) to provide users with precise and reliable tax advice, thereby simplifying the complex task of tax preparation and filing.

For example, in the domain of tax preparation, the automated corpus tool generator (according to the method in FIG. 2B) may ingest a corpus of tax-related documents, such as tax forms, tax codes, and tax regulations. These documents may be converted into a digestible format suitable for downstream processing. The converted corpus may then be analyzed using a series of machine learning models to extract generalized information about the corpus. In the context of tax data, the generalized information extracted by the automated corpus tool generator may include semantic groupings of tax codes and regulations, representative keywords such as “deduction”, “income”, or “non-resident”, and a summarization of each section of the tax corpus, providing a comprehensive overview of tax-related information. This analysis may result in the identification of semantic groupings, representative keywords, and correlations to predefined categories within the tax-related corpus. In the context of tax data, the automated corpus tool generator may identify semantic groupings such as “income tax”, “property tax”, and “sales tax”, representative keywords like “deduction”, “income”, “non-resident”, and correlations to predefined categories such as correlating “deduction” with “income tax”, or “property” with “property tax”. The analyzed corpus may be collated and formatted, and metadata may be built. An example of collated and formatted tax data may be a structured dataset containing information from various tax forms, such as Form 1040 and Schedule C, where each row represents a taxpayer's data, and columns represent specific tax attributes like gross income, deductions, tax credits, and final tax liability. This metadata may be used to create embeddings, which are vectorized representations of the metadata. An example of vectorized representations of tax data may be a multi-dimensional vector where each dimension represents a specific tax attribute such as gross income, deductions, tax credits, and final tax liability, and the value in each dimension corresponds to the numerical value of that attribute for a specific taxpayer. The embeddings may be utilized to create a domain-specific agent for tax preparation, which may be deployed as an agent tool.

The LLM (according to the method in FIG. 3B) may utilize the created domain-specific agent for tax preparation or to perform tax-related tasks. For example, when a user submits a tax-related query via the user interface, the LLM agent may receive the query. An example of a tax-related query may be, “What are the current federal income tax brackets for a single filer in the United States?” The LLM agent may utilize the metadata generated by the domain-specific agent for tax preparation. This metadata may guide the LLM agent in accessing the vectorized datastores related to the relevant sections of the tax-related corpus. An example of metadata in the context of tax brackets may be a structured dataset containing information about tax brackets for a single filer in the United States, with each row representing a different income range and columns representing specific attributes such as the lower limit, upper limit, and tax rate for each bracket. Correspondingly, an example of vectorized data may be a multi-dimensional vector where each dimension represents a specific attribute such as the lower limit, upper limit, and tax rate, and the value in each dimension corresponds to the numerical value of that attribute for a specific income range. The LLM agent may generate a response to the user query based on the information accessed from the vectorized datastores and the domain knowledge tools. This may involve providing accurate and contextually relevant information about tax regulations, procedures, and forms, thereby simplifying the complex task of tax preparation and filing for users.

The automated corpus tool generator in accordance with the disclosed principles has a wide range of potential applications. It can be used across various domains, making it a valuable tool for a multitude of use cases. For example, it can be used, as mentioned above, to assist with tax preparation and filing, help Small and Medium-sized Businesses (SMBs) comply with regulatory requirements, streamline payroll processes, and alert users to changes in jurisdictional regulations. These are just a few examples of the potential applications of the automated corpus tool generator. Its ability to ingest and process a corpus of documents in various formats, generate domain-specific tools, and enhance the functionality of LLMs makes it a versatile and adaptable tool that can be applied to many more use cases.

The LLM may have access to a multitude of domain-specific agents, each created and maintained by an automated corpus tool generator in accordance with the disclosed principles. These agents are designed to provide the LLM with domain-specific, contextually relevant information, thereby enhancing the LLM's ability to generate accurate responses to user queries. The LLM may determine which domain-specific agent to utilize based on the nature of the user query. For instance, if the user query pertains to tax document preparation, the LLM may utilize a domain-specific agent created for the tax domain. This decision is guided by the metadata associated with each domain-specific agent, which provides an overview of the content and context of the information that the agent can provide. Thus, the LLM can select the appropriate domain-specific agent to utilize, ensuring that the responses generated are accurate, relevant, and contextually appropriate for the specific domain of the user query.

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are example and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A method for generating domain knowledge tools for a Large Language Model (LLM) agent, the method comprising:
analyzing a corpus of documents using a series of machine learning models to extract generalized information about the corpus; and
generating a domain specific agent that utilizes the generalized information to create and maintain domain knowledge tools that provide domain-specific contextually relevant information to the LLM agent, the domain knowledge tools enhancing the LLM agent processing of user queries by supplying domain-specific information and context during the LLM agent generation of responses.

2. The method of claim 1, further comprising:
converting of the corpus of documents into the digestible format comprises converting formatted documents into a text or binary equivalent format prior to the analyzing of the corpus of documents.

3. The method of claim 1, wherein the analyzing of the corpus comprises discerning logical or semantic groupings within the corpus, resulting in sections within the corpus.

4. The method of claim 3, further comprising:
performing, for each section of the corpus, an analysis to provide representative keywords, correlation to predefined categories, summarization of a section corpus, and identification of related sections and correlation between each section.

5. The method of claim 1, wherein the generating of the domain knowledge tools comprises creating domain-specific vectorized datastores that are utilized by the LLM agent to access the domain specific information and assist the LLM agent generation of the responses.

6. The method of claim 1, wherein the enhancing of the LLM agent processing comprises the LLM agent accessing the domain knowledge tools to provide accurate completions based upon specific prompts.

7. The method of claim 1, further comprising:
updating the domain knowledge tools automatically by the domain specific agent as the corpus is being updated, and reflecting changes as updates occur.

8. The method of claim 1, further comprising:
generating the domain knowledge tools by a plurality of domain specific agents to assist the LLM agent in providing accurate responses in various domains serviced by the LLM agent.

9. The method of claim 1, further comprising:
utilizing, by the LLM agent, the domain knowledge tools to reduce hallucinations and ensure accurate results in response to the user queries.

10. The method of claim 1, further comprising:
upon receiving a user query, utilizing, by the LLM agent, metadata generated by the domain-specific agent to determine relevant sections of the corpus, and vectorized datastores related to those corpus sections created by the domain-specific agent to generate a response to the user query.

11. A method of a Large Language Model (LLM) agent utilizing domain knowledge tools, the method comprising:
receiving a user query;
accessing domain knowledge tools that provide domain-specific contextually relevant information to the LLM agent, the domain knowledge tools enhancing the LLM agent in processing of user queries by supplying domain-specific information and context during the LLM agent in generation of responses, the domain knowledge tools generated from generalized information extracted from a corpus of documents using a series of machine learning models; and
generating a response to the user query based on the accessed domain knowledge tools.

12. The method of claim 11, wherein the analysis of the corpus is performed by discerning logical or semantic groupings within the corpus, resulting in sections within the corpus.

13. The method of claim 12, wherein the analysis provides representative keywords, correlation to predefined categories, summarization of section corpus, and identification of related sections and correlation between the sections.

14. The method of claim 11, wherein the domain knowledge tools comprise domain-specific vectorized datastores that are utilized by the LLM agent to access the domain-specific information and assist the LLM agent generation of the responses.

15. The method of claim 11, wherein the LLM agent accesses the domain knowledge tools to provide accurate completions based upon specific prompts.

16. The method of claim 11, wherein the domain knowledge tools are automatically generated by a domain specific agent as the corpus is being updated.

17. The method of claim 11, wherein the domain knowledge tools are generated by a plurality of domain specific agents to assist the LLM agent in providing accurate responses in various domains serviced by the LLM agent.

18. The method of claim 11, further comprising:
utilizing, by the LLM agent, the domain knowledge tools to reduce hallucinations and ensure accurate results in response to the user query.

19. The method of claim 11, further comprising:
utilizing, by the LLM agent, metadata of the domain knowledge tools to determine relevant sections of the corpus, and vectorized datastores related to the metadata to generate the response to the user query.

20. A system for generating domain knowledge tools for a Large Language Model (LLM) agent, the system comprising:
a database storing a corpus of documents; and
a processor configured to:
analyze the corpus of documents using a series of machine learning models to extract generalized information about the corpus, and generate a domain specific agent that utilizes the generalized information to create and maintain domain knowledge tools that provide domain-specific contextually relevant information to the LLM agent, the domain knowledge tools enhancing the LLM agent processing of user queries by supplying domain-specific information and context during the LLM agent generation of responses.
